(19) United States
(12) Patent Application Publication
(10) Pub. No.: US 2017/0032256 A1
(43) Pub. Date: Feb. 2, 2017

(54) SYSTEMS AND METHOD OF SELECTING MUSIC FOR PREDICTED EVENTS

(71) Applicant: Google Inc., Mountain View, CA (US)

(72) Inventors: Owen Daniel Otto, Berkeley, CA (US); Brandon Bilinski, San Francisco, CA (US)

(21) Appl. No.: 14/812,208

(22) Filed: Jul. 29, 2015

(51) Int. Cl. G06N 5/04; G06F 17/30; H04L 29/08; H04L 29/06

(52) U.S. Cl. CPC G06N 5/04; H04L 65/60; G06F 17/30772; H04L 67/10

(57) ABSTRACT

Systems and methods of the disclosed subject matter provide predicting, by an electronic device, a future event at which media is to be played, predicting, by the electronic device according to data stored in a storage device, whether a communications network connection will be available at one or more locations of the predicted future event, generating, by the electronic device, a playlist of a plurality of media according to the predicted future event; and when it is predicted that the communications network connection will be unavailable or intermittent at the one or more locations, downloading, by the electronic device from a server while the communications network connection is available, at least one of the plurality of media from the generated playlist and storing the downloaded media on the storage device of the electronic device.

### BACKGROUND

Users want to have the perfect media, such as music or video, ready to play for any moment with little effort or preparation. For example, a user may attend an outdoor event (e.g., an outdoor barbecue) with no Wi-Fi connectivity, but may still want to play appropriate music for the outdoor event. In another example, the user can be driving and want to hear good driving music that starts without buffering and continues to provide music, even when a network connection is interrupted. In another example, a user may be travelling by train, and may want to play a movie that starts without buffering and continues playing, even when a network connection is interrupted.

Typically, these situations require users to predict their future situations and manually prepare by selecting music to be downloaded to a mobile device while a Wi-Fi or other network connection is available. In this scenario, a user would need to remove the downloaded media to free up storage space on the device.

These steps require work by the user. Often, a user forgets to do this preparation of downloading songs or video ahead of an event, and thus may be in a situation without appropriate media on-hand.

### BRIEF SUMMARY

Implementations of the disclosed subject matter provide systems and methods of predicting a user's future context for playing media (e.g., listening to music, playing video, or the like) so as to minimize the amount of planning and the number of user interactions with the electronic device in order to play media. At an appropriate time, such as overnight while the user's device is plugged in to charge a battery and is connected to a Wi-Fi network, the systems and methods of the disclosed subject matter may predict the user's likely media playback situations for an upcoming time period (e.g., the next day).

The system of the disclosed subject matter may determine and/or predict a user's likely media playback situations, and may select appropriate media (e.g., music, video, or the like) based on one or more signals. Example signals may include: media that the user has played at a given location or has played to before; holidays; weather (e.g., predicted weather forecast); data indicating a concert that the user is attending soon; direction data from a maps application; how fast the user is driving; the user's heart rate; whether headphones are connected to the user's device; and whether a speaker is connected to the device; and an identification of the user.

The system of the disclosed subject matter may determine and/or consider the user's taste (e.g., user's preferences regarding music and/or videos, including artists, albums, genres, directors, actors, and the like) and other signals, and may select playlists for the user to play back in these future situations.

For any situation in which the user is likely to have no network connection and/or a poor connection (e.g., while on a plane or driving), the system may download the appropriate playlist ahead of time while the user's device is connected to Wi-Fi. In some implementations, one or more songs, video, or the like of the playlist may be downloaded.

In some implementations, the system may download media (e.g., music, videos, or the like) for situations in which the user may have, for example, a cellular network connection, but would like to avoid data charges or the system may download the first media item (e.g., song, video, or the like) of all playlists so that playback can begin immediately without the need to stream from a network server.

According to an implementation of the disclosed subject matter, a method provides predicting, by an electronic device, a future event at which media is to be played, predicting, by the electronic device according to data stored in a storage device, whether a communications network connection will be available at one or more locations of the predicted future event, generating, by the electronic device, a playlist of a plurality of media according to the predicted future event, and when it is predicted that the communications network connection will be unavailable or intermittent at the one or more locations, downloading, by the electronic device from a server while the communications network connection is available, at least one of the plurality of media from the generated playlist and storing the downloaded at least one of the media on the storage device of the electronic device.

According to an implementation of the disclosed subject matter, a system provides a storage device to store data, and an electronic device, communicatively coupled to the storage device, to predict a future event at which media is to be played, to predict whether a communications network connection will be available at one or more locations of the predicted future event according to the data stored in a storage device, to generate a playlist of a plurality of media according to the predicted future event, and when it is predicted that the communications network connection will be unavailable or intermittent at the one or more locations, to download at least one of the plurality of media from the generated playlist from a server while a communications network connection is available and to store the downloaded at least one of the plurality of media on the storage device of the electronic device.

According to an implementation of the disclosed subject matter, means for selecting media for predicted events are provided that include predicting, by an electronic device, a future event at which media is to be played, predicting, by the electronic device according to data stored in a storage device, whether a communications network connection will be available at one or more locations of the predicted future event, generating, by the electronic device, a playlist of a plurality of media according to the predicted future event, and when it is predicted that the communications network connection will be unavailable or intermittent at the one or more locations, downloading, by the electronic device from a server while the communications network connection is available, at least one of the plurality of media from the generated playlist and storing the downloaded at least one of the plurality of media on the storage device of the electronic device.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example method of predicting an event and generating an appropriate playlist of media for the predicted event according to an implementation of the disclosed subject matter.

FIG. 2 shows an example display on an electronic device of the generated playlists for a plurality of events according to an implementation of the disclosed subject matter.

FIG. 3 shows an example display on the electronic device of a playlist being played in response to a morning alarm set on the electronic device according to an implementation of the disclosed subject matter.

FIG. 4 shows an example display on the electronic device of a playlist being played for a morning commute, where the device may have intermittent connectivity, according to an implementation of the disclosed subject matter.

FIG. 5 shows a computing device according to an implementation of the disclosed subject matter.

FIG. 6 shows a network configuration according to an implementation of the disclosed subject matter.

FIG. 7 shows an example network and system configuration according to an implementation of the disclosed subject matter

### DETAILED DESCRIPTION

Implementations of the disclosed subject matter provide systems and methods of predicting a user's future context for playing media so that media may be readily available to play back. The media may be music, video, movies, or the like. The implementations may consider whether a user's device may connect to a communications network, and whether the connection may be intermittent. At an appropriate time, such as overnight while the user's device is plugged in to charge a battery and is connected to a Wi-Fi or other communications network, the systems and methods of the disclosed subject matter may predict the user's likely media playback situations for an upcoming time period.

The system can model the user′ likely listening situations and appropriate media based on one or more signals. The likely playback situation may include a user's commute to work. For example, a user's typical commute times and transportation mode (e.g., car, bus, subway, train, or the like) may be based on GPS (global positioning system) data and/or other movement data from the user's device. From this data, the system may determine that the user typically drives to work at 6:30 AM on weekdays. The system may determine the locations where a user typically spends time from the data. For example, the data may indicate that the user spends time at home in the morning (e.g., before 6:30 AM) and evening (e.g., at 6:00 PM or later), and at a place of work during the day (e.g., 7:30 AM to 5:00 PM). In determining appropriate media, the system may consider playback behavior on, for example, previous days (e.g., both when media was played back and what kind (e.g., type, genre, or the like) of media was listened to). The system of the disclosed subject matter may determine appropriate media (e.g., music) according to alarm settings in a clock application running on a user's device, and/or events entered in a calendar application running on the user's device.

The system of the disclosed subject matter may generate a list of likely listening situations, and may match those to appropriate media content based on the user's taste and/or preferences. For example, the system may determine the user's schedule to be the following:

| | | |
|---|---|---|
| 5:30AM | Wake up and get ready | Location: Home |
| 6:30AM | Work out | Location: Gym |
| 8:00AM | Drive to work | Location: Car |
| 9:00AM | Work | Location: Office |
| 5:30PM | Drive home | Location: Car |
| 6:30PM | Relax | Location: Home |

Based at least in part of the user's schedule and other signals, the system may select playlists for the user to play to in these future situations. Example signals may include: media that the user has played at a given location or has played back before; holidays (e.g., Christmas music and/or videos may be selected when Christmas Day is approaching); weather (e.g., weather forecast signals); data indicating a concert that the user is attending soon (e.g., from an electronic calendar application, from ticket receipt data, or the like); direction data from a maps application (e.g., the user has an upcoming subway commute underground, an airplane flight, or a long drive in traffic); how fast the driver is driving; the user's heart rate (e.g., from smart watch data, where the data may be used to determine the user is exercising, relaxed, or the like); whether headphones are connected to the user's device (e.g., the system may not have to play “safe for work” music and/or videos if the headphones are determined to be connected); whether a speaker is connected to the device (e.g., if a speaker being connected to is in a child's bedroom and/or playroom, the system may recommend children's music); an identification of the user (e.g., the system may detect a plurality of people talking nearby and may recommend party music, and/or may determine the identity of the users nearby according to data received from the devices of the nearby persons and provide the recommendations for the group of persons).

For any situation in which the user is likely to have no network connection and/or a poor connection (e.g., while on a plane or driving), the system may download the appropriate playlist ahead of time while the user's device is connected to Wi-Fi.

The system may download media items for situations in which the user may have, for example, a cellular network connection, but want to avoid data charges or the system may download the first media item of all playlists so that playback can begin immediately without the need to stream from a network server.

In implementations of the disclosed subject matter, the system may predict the user's likely media playback contexts in advance, and may match them with appropriate playlists for a given user's taste and/or preferences.

In some existing systems, a user may specify a context to get appropriate media, but such systems all require input from the user, as well as communication with a server. In implementations of the disclosed subject matter, the system may allow a user to, for example, arrive at the gym, plug in headphones to a user device, and have appropriate workout music to start playing immediately, without a connection to the Internet. If the user needs music available offline for a particular situation and/or event, the system may provide the user with an appropriate playlist, music, and/or video downloaded ahead of time, without the user taking any action or planning in advance.

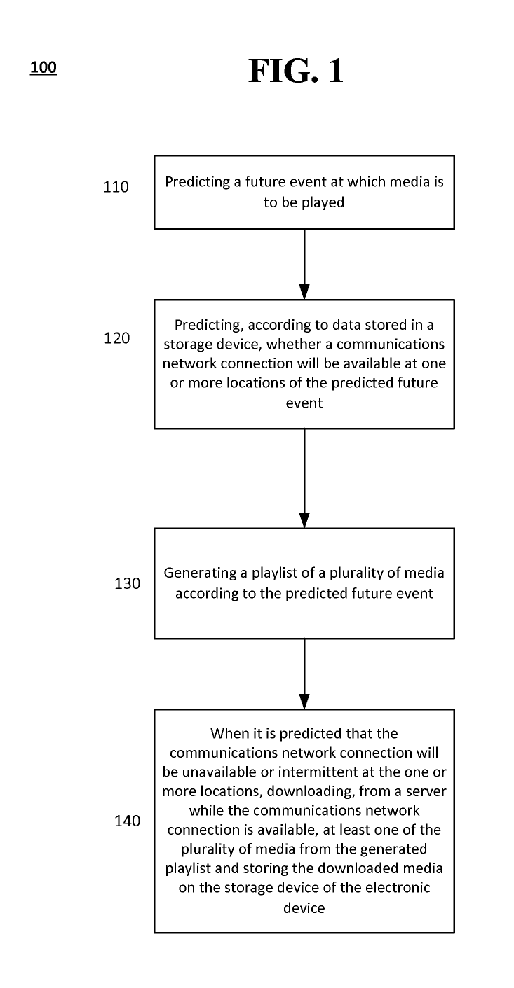

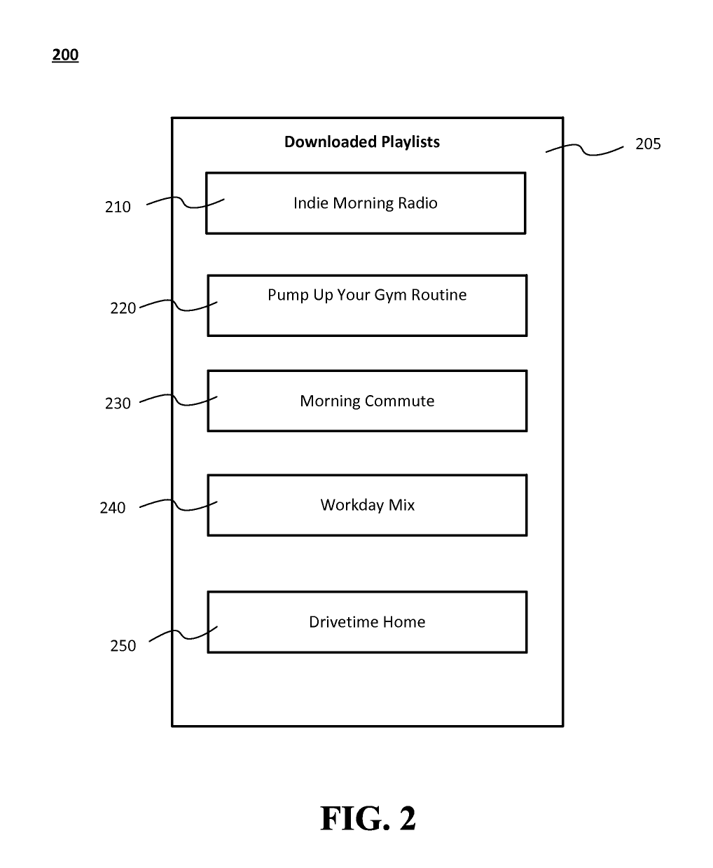

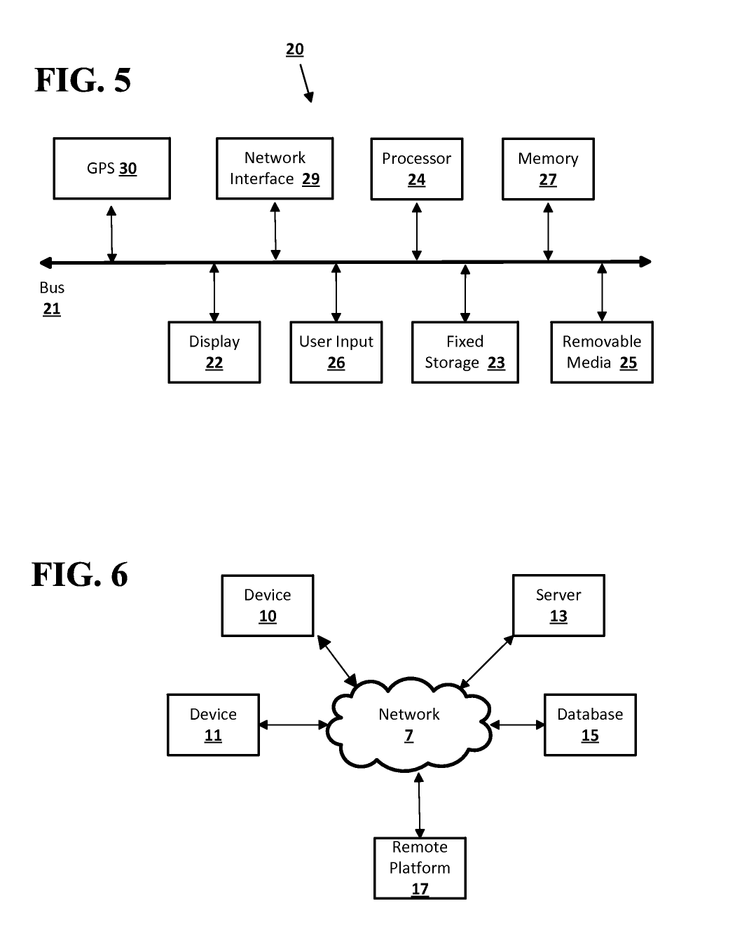

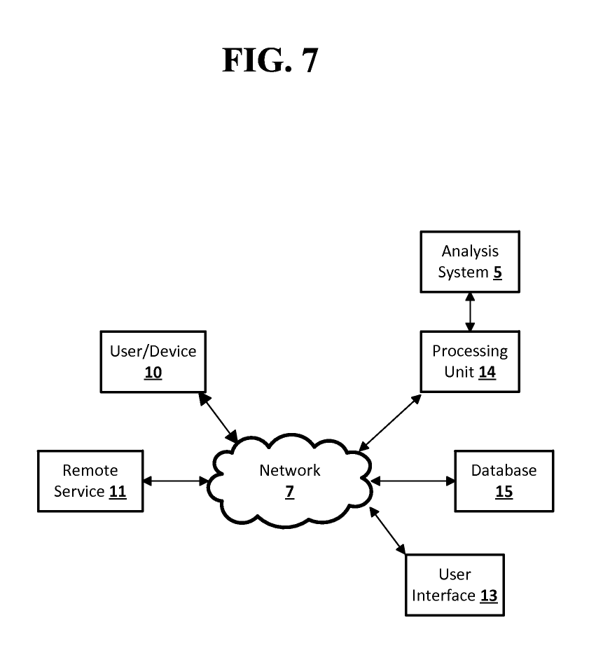

FIG. 1 shows an example method 100 of predicting an event and generating an appropriate playlist of media for the predicted event according to an implementation of the disclosed subject matter. In operation 110, an electronic device (e.g., electronic device 200 shown in FIGS. 2-4, device 20 shown in FIG. 5, and/or devices 10, 11 shown in FIGS. 6-7), may predict a future event at which media is to be played. For example, the future event may be a commute (e.g., via train, car, bus, or the like), a gym session, a party and/or other gathering, work, leisure time at home, or the like. As discussed above, the electronic device may use data stored (e.g., in fixed storage 23 and/or removable media 25 shown in FIG. 5, and/or server 13 and/or database 15 shown in FIG. 6) to predict the event. The data may include GPS data for location, electronic “check-in” data entered by the user and/or acquired by an application executed by the electronic device to confirm a user's location, alarm data for events set by the user to have a reminder alarm, calendar data (e.g., upcoming concert and/or events), or the like.

In some implementations, the predicted future event at which media is to be played is predicted by the electronic device according to at least one of travel time according to data stored in the storage device, one or more locations where a user spends time, media playback behavior data on at least one previous day that is stored in the storage device, according to alarm data stored in the storage device, event data for a calendar application stored in the storage device, and the like.

In operation 120, the electronic device may predict, according to the stored data, whether a communications network connection will be available at one or more locations of the predicted future event. The communications network connection (e.g., via network 7 shown in FIG. 6) may be between the electronic device (e.g., devices 10, 11 shown in FIG. 6) and a server and/or database (e.g., server 13 and/or database 15 shown in FIG. 6). That is, the electronic device may search the stored data to determine if the electronic device was connected to one or more communications networks previously when in a similar location as the predicted event, and/or whether there were network connectivity issues. For example, if the predicted event is a commute, there may be locations (e.g., along the route of the commute) in which the stored data shows that the connection to at least one network is intermittent and/or unavailable. In another example, if the predicted event is a work day for the user, the data may indicate that the location of the user's work site may have uninterrupted connectivity to a communications network. In another example, the predicted event is travel, and the calendar data indicates that the trip involves air travel, the electronic device may predict that there may be no network connection available for the duration of the flight.

At operation 130, the electronic device may generate a playlist of a plurality of media according to the predicted future event. The playlist may include music, videos, movies, and/or any suitable combination thereof. When generating the playlist, the electronic device may determine which media and/or genres of media the user may have played to at the same or similar event. The playlist may include more than one genre, if, for example, the user media preference history for the same or similar event indicates the preference for a plurality of genres. For example, if the predicted event is a training session at the gym, the electronic device may select upbeat music within the same or similar genre that the user may have used during previous training sessions (e.g., electronic music, dance music, pop music, hip-hop, or the like).

In some implementations, the electronic device may generate the playlist according to a type of the electronic device (e.g., smart phone, smart watch, tablet computer, digital multimedia device, wearable computing device, laptop computer, desktop computer, or the like), the predicted future event, and the one or more locations of the future event. For example, the playlist generated for a training session at the gym may be for a smart phone, digital multimedia device, or the like, which may be different from a playlist that is generated for a desktop computer for a workplace media playback session.

The electronic device may predict the duration of the event. This prediction may be used to generate a playlist of media (e.g., songs, videos, or the like). For example, if the event is determined to be a multi-state road trip via car, the electronic device may for example, generate a playlist with sufficient length and variety of genres to accommodate the user's tastes for music for the predicted duration of the road trip. In another example, the event may be a morning commute to work via subway, where the predicted duration may be 30 minutes. The electronic device may generate a playlist with at least 30 minutes of songs and/or video for the predicted duration of the event.

In some implementations, the generating the media for the playlist may in operation 130 may include predicting a context for playing the media. The predicting may be performed according to at least one of a location, a user's media genre preference, the user's schedule, an activity, and the predicted future event. The electronic device may select music of the playlist according to the predicted context. The context may be, for example, leisure time at home for listening to music and/or watching videos, an outdoor picnic or barbecue, a house party, or the like. That is, the location of an event and the context may be considered by the electronic device in generating a playlist. That is, although a location of an event may be a public park, the context may be, for example, an outdoor barbeque or may be reading a book while wanting to listen to music as well.

The electronic device may generate the playlist by selecting songs, videos, or the like according to at least one of media that a user has listened to at a given location, media that the user has played before, a calendar holiday, a weather prediction, data indicating a concert that the user is attending soon, direction data from a maps application of the electronic device, how fast the user is driving, the user's heart rate data that is communicated to the electronic device from a heart rate monitoring device, whether headphones are connected to the electronic device, whether a speaker is connected to the electronic device, an identification of the user, and the like.

At operation 140, when it is predicted that the communications network connection may be unavailable or intermittent at the one or more locations, the electronic device may download one or more media from a server (e.g., server 13 and/or database 15 shown in FIG. 6) while the communications network connection is available. The media may be one or more of the songs, video, or the like from the generated playlist. The downloaded media may be stored on the storage device of the electronic device (e.g., fixed storage 23 and/or removable media 25 shown in FIG. 6).

In some implementations, the electronic device may predict a different future event (e.g., a second event) at which media is to be played. The electronic device may assign one or more media of the previously-generated playlist (e.g., for a first event) to a second playlist for the different future event (e.g., the second event). For example, if the predicted first event is a workout session at the gym, and the second event is a party event, the electronic device may add one or more songs to a new playlist for the different future event that were included on the previously-generated playlist. That is, the electronic device may use stored data and the prediction to determine the song and genre preferences for the user and the different event, and generate the new playlist.

The operation 140 may include predicting, by the electronic device according to data stored in the storage device, the duration that the communications network connection is unavailable or intermittent at the one or more locations, and downloading the at least one of the plurality of media from the generated playlist according to the predicted duration.

In some implementations, the method 100 may include playing the downloaded at least one of the plurality of media from the generated playlist from the storage device, and streaming, from the server communicatively coupled to the electronic device via the communications network, the remaining media of the plurality of media from the generated playlist for playback that were not stored on the storage device.

In some implementations, the storing the downloaded at least one of the plurality of media on the storage device of the electronic device in method 100 may include caching the at least one of the plurality of media on the storage device when the electronic device is plugged in to receive power or is in an idle state.

Although the operations 110, 120, 130, and 140 are described above as using an electronic device, the operations of method 100, in some implementations, may be performed at least in part, by a server, database, remote system, and/or analysis system (e.g., server 13, database 15, remote platform 17, and/or processing unit 15 and analysis system 5 shown in FIGS. 6-7).

FIG. 2 shows an electronic device 200 having a display 205 of generated playlists that have been downloaded by the electronic device 200. The electronic device 200 may be device 20 shown in FIG. 5 and discussed below, and/or devices 10, 11 shown in FIGS. 6-7 and discussed below. Although five different playlists (e.g., playlists 210, 220, 230, 240, and 250) are displayed on the display 205, there may be one or more playlists downloaded and/or displayed on the display 205. That is, there may be greater or fewer playlists downloaded by the electronic device 200 than the five playlists displayed in display 205.

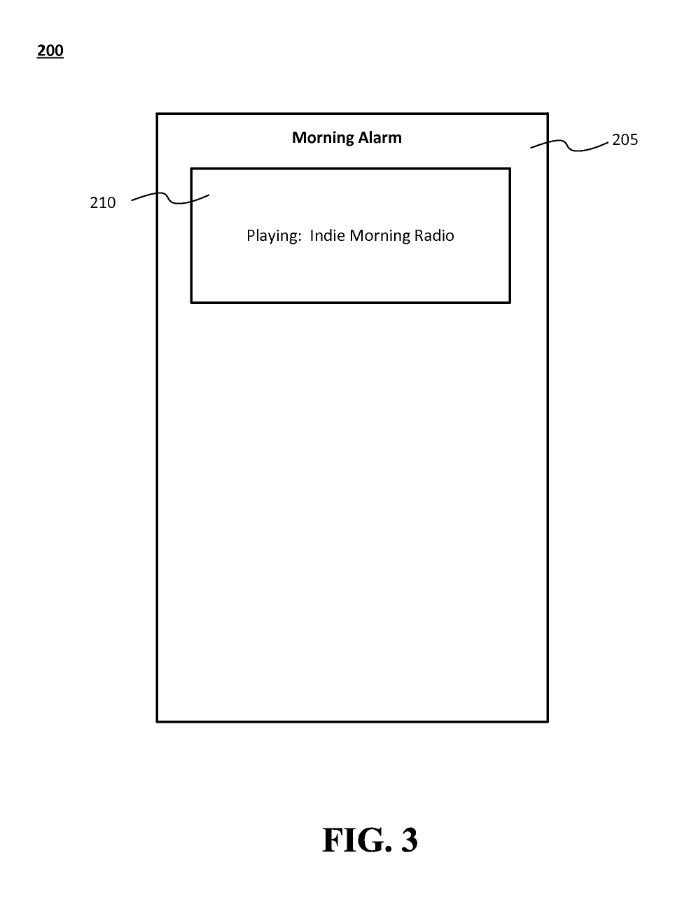

Playlists 210, 220, 230, 240, and 250 may be playlists generated for different events that are predicted by the electronic device 200. For example, playlist 210 may be a playlist that is generated and downloaded to be used for a user's morning alarm set in a clock application being executed by the electronic device 200. The “Indie Morning Radio” playlist 210 may include songs according to the user's taste and one or more signals (e.g., weather forecast) that are selected for the playlist to be generated. In this example, as the user may be at home during the morning, it is likely that the user may have access to a Wi-Fi connection, and the electronic device may refrain from downloading songs from the playlist 210 to be stored in a storage device on the electronic device 200. FIG. 3 shows the electronic device 200 playing songs from the playlist 210 according to the alarm event (e.g., a morning alarm).

The playlist 220 of FIG. 2 may be generated and downloaded according to the predicted event of a training session at a gym. This event may be predicted according to calendar data stored in a storage device of the electronic device 200, and/or may be predicted according to previously stored GPS data. That is, the “Pump Up Your Gym Routine” playlist 220 may include songs according to the user's taste and one or more signals that are selected for the playlist to be generated. In this example, as the user may be at the gym during the event, and there may not be a Wi-Fi connection and/or there may be an interrupted connection to the Wi-Fi connection. Thus, the electronic device may download one or more songs of the playlist prior to the event so that the user may have access to the songs.

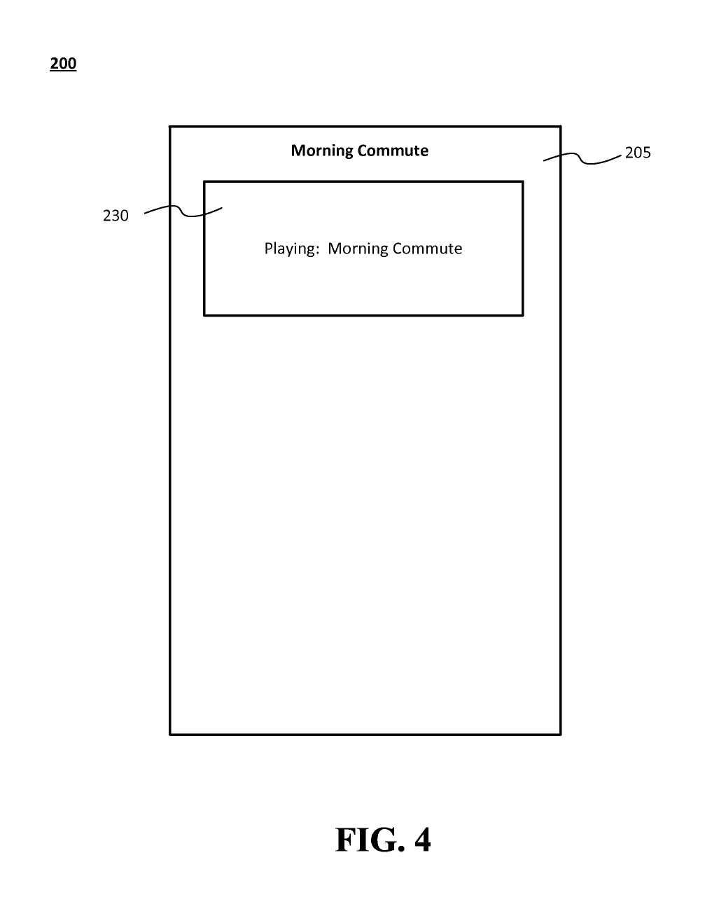

The playlist 230 may be generated and downloaded according to a predicted commute to work by the user via automobile. This event may be predicted according to at least previously stored GPS data. That is, the “Morning Commute” playlist 230 may include songs according to the user's taste and one or more signals that are selected for the playlist to be generated. FIG. 4 shows the electronic device playing songs from the playlist 230 during the event. In this example, as the user is in a car during the event, there may not be a Wi-Fi connection and/or there may be an interrupted connection to the Wi-Fi connection. Thus, the electronic device may download one or more songs of the playlist prior to the event so that the user may have access to the songs.

The playlist 240 may be generated and downloaded according to a predicted work schedule of the user. This event may be predicted according to at least previously stored GPS data and/or calendar data. That is, the “Workday Mix” playlist 240 may include songs according to the user's taste and one or more signals that are selected for the playlist to be generated. In this example, as the user is in an office during the event, there may be a Wi-Fi and/or other network connection. Thus, the electronic device may refrain from downloading one or more songs of the playlist prior to the event.

The playlist 250 may be generated and downloaded according to a predicted commute home by the user via automobile. This event may be predicted according to at least previously stored GPS data. That is, the “Drivetime Home” playlist 250 may include songs according to the user's taste and one or more signals that are selected for the playlist to be generated. In this example, as the user is in a car during the event, there may not be a Wi-Fi connection and/or there may be an interrupted connection to the Wi-Fi connection. Thus, the electronic device may download one or more songs of the playlist prior to the event so that the user may have access to the songs.

In situations in which the systems discussed here collect personal information about users (e.g., tastes and/or preferences in genres of music, personal schedule, GPS data), or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location (e.g., from the GPS data) may be generalized where location information is obtained (such as to a city, ZIP code, or state level), so that a particular location of a user cannot be determined. Thus, the user may have control over how information is collected about the user and used by a system as disclosed herein.

Implementations of the presently disclosed subject matter may be used with a variety of component and network architectures. FIG. 5 is an example electronic device 20 suitable for implementing implementations of the presently disclosed subject matter. The device 20 may be, for example, a desktop or laptop computer, or a mobile computing device such as a smart phone, tablet, or the like. The device 20 may be the electronic device 200 shown in FIGS. 2-4 and discussed above. The device 20 may include a bus 21 which interconnects major components of the device 20, such as a central processor 24, a memory 27, such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, a network interface 29 operable to communicate with one or more remote devices via a suitable network connection, and a GPS device 30 to determine the geographic location of the device 20.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the device 20 are generally stored on and accessed via a computer readable medium, such as a hard disk drive (e.g., fixed storage 23), an optical drive, floppy disk, or other storage medium.

The fixed storage 23 may be integral with the device 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks, as described in further detail below.

The GPS device 30 may determine the geographic location of the device 20 according to a GPS satellite communications network.

Many other devices or components (not shown) may be connected in a similar manner (e.g., document scanners, digital cameras and so on). Conversely, all of the components shown in FIG. 5 need not be present to practice the present disclosure. The components can be interconnected in different ways from that shown. The operation of a computer such as that shown in FIG. 5 is readily known in the art and is not discussed in detail in this application. Code to implement the present disclosure can be stored in computer-readable storage media such as one or more of the memory 27, fixed storage 23, removable media 25, or on a remote storage location.

FIG. 6 shows an example network arrangement according to an implementation of the disclosed subject matter. One or more devices 10, 11, such as local computers, smart phones, smart watches, wearable computing devices, digital media players, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15.

The server 13, database 15, and/or remote platform 17 may be used in some implementations of the disclosed subject matter to perform at least a portion of predicting a future event at which music may be played (e.g., operation 110 shown in FIG. 1), predicting whether a communications network connection will be available at one or more locations of the predicted future event (e.g., operation 120 shown in FIG. 1), and generating a playlist of media according to the predicted future event (e.g., operation 130 shown in FIG. 1). The server 13, database 15, and/or remote platform 17 may store generated playlists, music, and/or videos from the generated playlists, and the devices 10, 11, device 20, and/or device 200 may download the generated playlists, music, and/or videos from the server 13, database 15, and/or remote platform 17 (e.g., operation 140 shown in FIG. 1).

FIG. 7 shows an example arrangement according to an implementation of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

In some implementations of the disclosed subject matter, the processing unit 14 and/or the analysis system 5 may to perform at least a portion of predicting a future event at which music may be played (e.g., operation 110 shown in FIG. 1), predicting whether a communications network connection will be available at one or more locations of the predicted future event (e.g., operation 120 shown in FIG. 1), and generating a playlist of media according to the predicted future event (e.g., operation 130 shown in FIG. 1).

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
predicting, by an electronic device, a future event at which media is to be played;
predicting, by the electronic device according to data stored in a storage device, whether a communications network connection will be available at one or more locations of the predicted future event;
generating, by the electronic device, a playlist of a plurality of media according to the predicted future event; and
when it is predicted that the communications network connection will be unavailable or intermittent at the one or more locations, downloading, by the electronic device from a server while the communications network connection is available, at least one of the plurality of media from the generated playlist and storing the downloaded at least one of the plurality of media on the storage device of the electronic device.

2. The method of claim 1, wherein the generating the playlist comprises:
generating, by the electronic device, the playlist according to at least one of a type of the electronic device, the predicted future event, and the one or more locations of the future event.

3. The method of claim 1, further comprising:
predicting, by an electronic device, a different future event at which media is to be played;
assigning, by the electronic device, one or more media of the generated playlist to a second playlist for the different future event.

4. The method of claim 1, wherein the generating the playlist further comprises:
predicting, by the electronic device, a duration of the future event.

5. The method of claim 1, wherein the generating the music for the playlist comprises:
predicting, by the electronic device, a context for playing the media; and
selecting, by the electronic device, the music of the playlist according to the predicted context.

6. The method of claim 5, wherein the predicting is according to at least one selected from the group consisting of: at least one of a location, a user's media genre preference, the user's schedule, an activity, and the predicted future event.

7. The method of claim 1, wherein the playlist is generated by selecting media according to at least one from the group consisting of: one or more media that a user has played to at a given location; one or more media that the user has played to before; a calendar holiday; a weather prediction; data indicating a concert that the user is attending soon; direction data from a maps application of the electronic device; how fast the user is driving; the user's heart rate data that is communicated to the electronic device from a heart rate monitoring device; whether headphones are connected to the electronic device; whether a speaker is connected to the electronic device; and an identification of the user.

8. The method of claim 1, wherein the predicted future event at which media is to be played is predicting according to at least one selected from the group consisting of: travel time according to data stored in the storage device; one or more locations where a user spends time; playback behavior data on at least one previous day that is stored in the storage device; according to alarm data stored in the storage device; and event data for a calendar application stored in the storage device.

9. The method of claim 1, wherein the downloading further comprises:
predicting, by the electronic device according to data stored in the storage device, the duration that the communications network connection is unavailable or intermittent at the one or more locations; and
downloading the at least one of the plurality of media from the generated playlist according to the predicted duration.

10. The method of claim 1, further comprising:
playing the downloaded at least one of the plurality of media from the generated playlist from the storage device; and
streaming, from the server communicatively coupled to the electronic device via the communications network, the remaining media of the plurality of media from the generated playlist for playback that were not stored on the storage device.

11. The method of claim 1, wherein the storing the downloaded at least one of the plurality of media on the storage device of the electronic device comprises:
caching the at least one of the plurality of media on the storage device when the electronic device is plugged in to receive power or is in an idle state.

12. A system comprising:
a storage device to store data; and
an electronic device, communicatively coupled to the storage device, to predict a future event at which media is to be played, to predict whether a communications network connection will be available at one or more locations of the predicted future event according to the data stored in a storage device, to generate a playlist of a plurality of media according to the predicted future event, and when it is predicted that the communications network connection will be unavailable or intermittent at the one or more locations, to download at least one of the plurality of media from the generated playlist from a server while a communications network connection is available and to store the downloaded at least one of the plurality of media on the storage device of the electronic device.

13. The system of claim 12, wherein the electronic device generates the playlist according to at least one of a type of the electronic device, the predicted future event, and the one or more locations of the predicted future event.

14. The system of claim 12, wherein the electronic device predicts a different future event at which media is to be played, and assigns one or more media of the generated playlist to a second playlist for the different future event.

15. The system of claim 12, wherein the electronic device predicts a duration of the predicted future event so as to generate the playlist.

16. The system of claim 12, wherein the electronic device predicts a context for playing the media and selects the media of the playlist according to the predicted context.

17. The system of claim 16, wherein the prediction by the electronic device is according to at least one selected from the group consisting of: at least one of a location, a user's media genre preference, the user's schedule, an activity, and the predicted future event.

18. The system of claim 12, wherein the electronic device generates a playlist by selecting media according to at least one from the group consisting of: one or more media that a user has listened to at a given location; one or more media that the user has listened to before; a calendar holiday; a weather prediction; data indicating a concert that the user is attending soon; direction data from a maps application of the electronic device; how fast the user is driving; the user's heart rate data that is communicated to the electronic device from a heart rate monitoring device; whether headphones are connected to the electronic device; whether a speaker is connected to the electronic device; and an identification of the user.

19. The system of claim 12, wherein the predicted future event at which media is to be played is predicted by the electronic device according to at least one selected from the group consisting of: travel time according to data stored in the storage device; one or more locations where a user spends time; playback behavior data on at least one previous day that is stored in the storage device; according to alarm data stored in the storage device; and event data for a calendar application stored in the storage device.

20. The system of claim 12, wherein the electronic device predicts, according to data stored in the storage device, the duration that the communications network connection is unavailable or intermittent at the one or more locations, and downloads the at least one of the plurality of media from the generated playlist according to the predicted duration.

21. The system of claim 12, wherein the electronic device plays the downloaded at least one of the plurality of media from the generated playlist from the storage device, and streams, from the server communicatively coupled to the electronic device via the communications network, the remaining media of the plurality of medias from the generated playlist for playback that were not stored on the storage device.

22. The system of claim 12, wherein the electronic device stores the downloaded at least one of the plurality of media on the storage device so as to cache the at least one of the plurality of media on the storage device when the electronic device is plugged in to receive power or is in an idle state.
